(19) United States
(12) Patent Application Publication
(10) Pub. No.: US 2023/0186411 A1
(43) Pub. Date: Jun. 15, 2023

(54) Optimized Hotel Room Display Ordering Based On Heterogenous Customer Dynamic Clustering

(71) Applicant: Oracle International Corporation, Redwood Shores, CA (US)

(72) Inventors: John Thomas COULTHURST, Steamboat Springs, CO (US); Denysse DIAZ, Sachse, TX (US); Jean-Philippe DUMONT, Columbia, MD (US); Chengyi LYU, Boulder, CO (US); Jorge Luis Rivero PEREZ, Naples, FL (US); Andrew VAKHUTINSKY, Sharon, MA (US); Alan WOOD, San Diego, CA (US)

(73) Assignee: Oracle International Corporation, Redwood Shores, CA (US)

(21) Appl. No.: 17/643,638

(22) Filed: Dec. 10, 2021

(51) Int. Cl. G06Q 50/12; G06Q 30/02; G06N 20/00

(52) U.S. Cl. CPC G06Q 50/12; G06Q 30/0206; G06N 20/00

(57) ABSTRACT

Embodiments optimize display ordering of reservable hotel room choices for a hotel. Embodiments receive a trained prediction demand model for the hotel, the trained prediction model including estimated coefficients, and receive a total inventory of hotel rooms for the hotel. Embodiments determine optimal Lagrangian coefficients from the estimated coefficients using a first iterative gradient search and determine optimized prices per customer based on the estimated coefficients and the optimal Lagrangian coefficients using a second iterative gradient search. Embodiments determine an offer order optimization per customer based on the optimal Lagrangian coefficients and using linear programming. Embodiments receive a request for a hotel room from a first customer, the request including one or more attributes. Based on the one or more attributes and the optimized prices per customer and the offer order optimization per customer, embodiments display an optimized ordered list of hotel room choices.

### FIELD

One embodiment is directed generally to a computer system, and in particular to a computer system that optimizes display ordering.

### BACKGROUND INFORMATION

Increased competition in the hotel industry has caused hoteliers to look for more innovative revenue management policies, such as personalized pricing and recommendations. Over the past few years, hoteliers have come to understand that not all guests are equal and a traditional one-size-fits-all policy might prove to be ineffective. Therefore, a need exists for hotels to profile their guests and offer them the right product/service at the right price and at the right format with the goal of maximizing their profit.

### SUMMARY

Embodiments optimize display ordering of reservable hotel room choices for a hotel. Embodiments receive a trained prediction demand model for the hotel, the trained prediction model including estimated coefficients, and receive a total inventory of hotel rooms for the hotel. Embodiments determine optimal Lagrangian coefficients from the estimated coefficients using a first iterative gradient search and determine optimized prices per customer based on the estimated coefficients and the optimal Lagrangian coefficients using a second iterative gradient search. Embodiments determine an offer order optimization per customer based on the optimal Lagrangian coefficients and using linear programming. Embodiments receive a request for a hotel room from a first customer, the request including one or more attributes. Based on the one or more attributes and the optimized prices per customer and the offer order optimization per customer, embodiments display an optimized ordered list of hotel room choices.

### BRIEF DESCRIPTION OF THE DRAWINGS

Further embodiments, details, advantages, and modifications will become apparent from the following detailed description of the embodiments, which is to be taken in conjunction with the accompanying drawings.

FIG. 1 is an overview block diagram of a hotel reservation system in accordance to embodiments of the invention.

FIG. 2 is a block diagram of a computer server/system in accordance with an embodiment of the present invention.

FIG. 3 is an overview block diagram of the functionality of the system of FIG. 1 in in accordance to embodiments of the invention.

FIG. 4 is a architectural diagram of the offer optimization model of FIG. 3 in accordance to embodiments.

FIG. 5 is a flow diagram that illustrates the functionality of the room hotel reservation system of FIG. 1 in accordance to embodiments.

FIG. 6 illustrates an example output solution from the functionality of FIG. 5 in accordance to embodiments of the invention.

FIG. 7 is a flow diagram of the functionality of the optimized display ordering module of FIG. 2 for generating a room demand model as part of the optimized display ordering functionality in accordance with one embodiment.

FIG. 8 illustrates an example of the initial clustering in accordance with embodiments.

FIG. 9 is an example illustrating various offered prices, room categories and rate codes.

FIG. 10 illustrates the choice modeling for guest clusters in accordance to example embodiments.

FIG. 11 illustrates the initial assignment of an MNL model to each cluster in accordance to embodiments.

### DETAILED DESCRIPTION

One embodiment optimizes the personalized ordering of the room category and rate plan combinations shown to a hotel-booking customer by a hotel reservation system. The optimized display ordering is based on the individual characteristics of the hotel customer as well as the features of the room categories and rate plans. The optimization objective is to maximize the expected revenue. Since the number of room categories and rate plans combinations can be very large, only a limited assortment of combinations is displayed to the customer, adding more complexity to the optimization. Embodiments solve the assortment optimization and display ordering problem efficiently using a linear-programming algorithm to obtain a high-quality approximate solution.

Embodiments optimizes displaying the set of hotel rooms in combination with the rate plans in order to maximize the expected revenue. In contrast to treating the customer population as homogenous with similar purchase preferences and behavior, embodiments provide a personalized solution based on the customer's characteristics known at the time of hotel booking, such as the length of stay, arrival day, booking channel, and booking window (i.e., how much in advance the booking is made), as well as other factors. The personalized offer display may include fewer booking options than the number of all possible combinations of room category and rate plans. In addition, the booking options in the offer are shown in the optimized order based on the estimated customer propensity to select options closer to the beginning of the list.

In order to optimize the display order, embodiments initially perform demand modeling. In general, in the hotel industry, as well as other comparative industries, increased competition is driving more innovative revenue management practices such as personalized offers and pricing. Not all customers are the same, and a traditional one-size-fits-all policy might prove to be ineffective. Accurate estimation of demand as an input to a personalized recommendation and display ordering system is crucial.

Embodiments address the need for a more accurate estimation of demand for hotel rooms by modeling the demand to account for heterogeneous customers with different: (1) Willingness-to-pay (indicated by the selected price range); (2) Rate plan selections (corporate discount, breakfast included, etc.); (3) Travel attributes; (4) Booking channels; (5) Booking windows; (6) Length of stay; (7) Date of arrival; and/or (8) Size of the group/family, number of children, etc. The factors influencing the choice can include room features, rate plan features, price, and the order in which the offers are shown.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

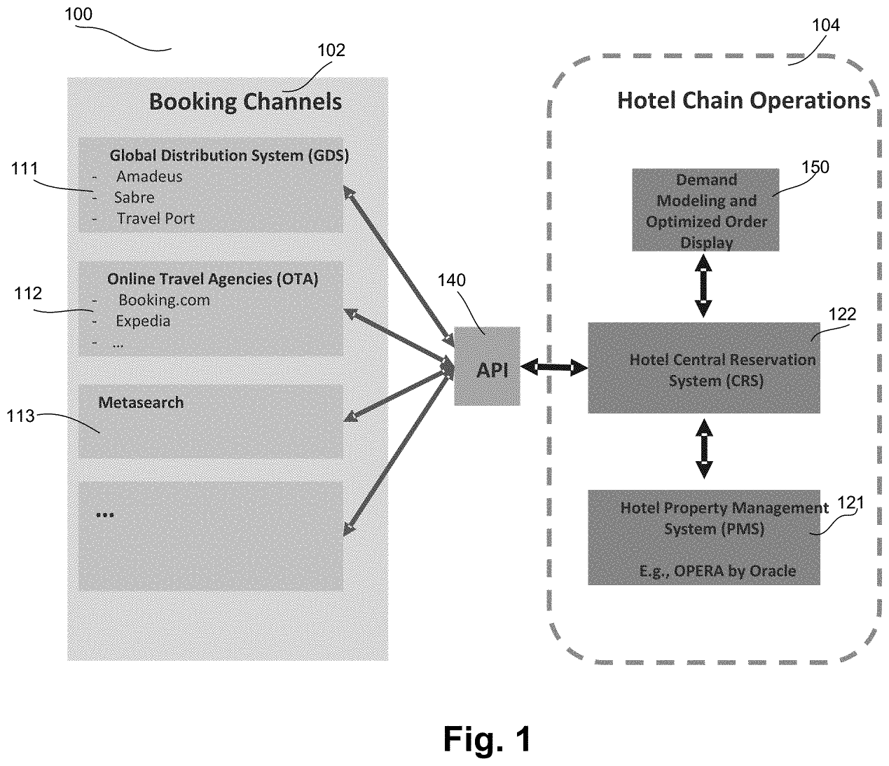

FIG. 1 is an overview block diagram of a hotel reservation system 100 in accordance to embodiments of the invention. FIG. 1 includes booking channels 102 that a potential hotel customer may interact with to reserve a hotel room. The channels include a Global Distribution System (“GDS”) 111, including “Amadeus”, “Sabre”, “Travel Port”, etc., Online Travel Agencies (“OTA”) 112, including “Booking.com”, “Expedia”, etc., Metasearch sites 113, and any other means for a customer to reserve a hotel room, including a website maintained by a hotel chain or individual hotel.

Each hotel chain operations 104 is accessed by an Application Programming Interface (“API”) 140 as a Web Service such as a “WebLogic Server” from Oracle Corp. Hotel chain operations 104 includes a Hotel Property Management System (“PMS”) 121, such as “OPERA Cloud Property Management” from Oracle Corp., a Hotel Central Reservation System (“CRS”) 122, and a Demand Modeling and Optimized Order Display module 150 that interfaces with systems 121 and 122 to provide optimized demand modeling and order display as disclosed herein.

A hotel customer or potential hotel customer that uses system 100 to obtain a hotel room typically engages in a three stage booking process. First an area availability search is conducted. Multiple hotel chains are shown and hotel CRS 122 provides static data. The static data can include the min/max rate, available dates, etc.

If the booking customer selects a hotel, they go to the next step which is the property search, including a single hotel property, multiple rooms and rate plans. For the single hotel property, information may include room category description data, rate plan description and room price, each of which is shown in a specific order. The property search includes real-time availability data and results in the booking customer selecting a room. Once the room is selected, the final step is final booking and the reservation being guaranteed by a credit card or other form of payment.

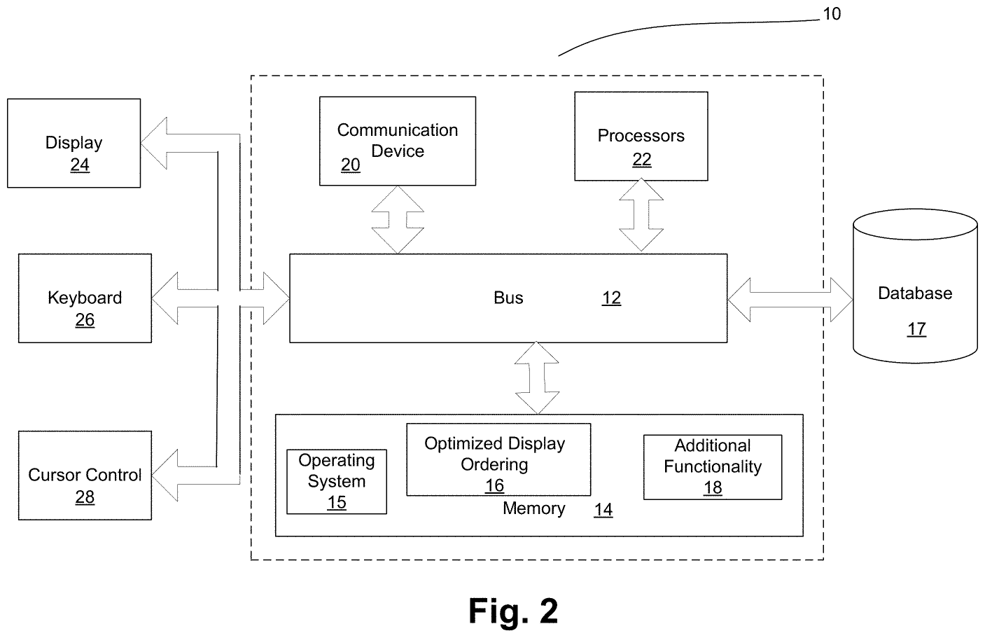

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, when implemented as a web server or cloud based functionality, system 10 is implemented as one or more servers, and user interfaces such as displays, mouse, etc. are not needed. In embodiments, system 10 can be used to implement any of the elements shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include optimized display ordering module 16 that optimizes the display ordering of hotel room options, to maximize the expected hotel room revenue, and all other functionality disclosed herein, including generating a predictive model in embodiments. As a hotel variable operating cost is relatively small, the expected revenue (i.e., the product of the room booking probability and room price) is the main optimization objective in embodiments. System 10 can be part of a larger system. Therefore, system 10 can include one or more additional functional modules 18 to include the additional functionality, such as the functionality of a Property Management System (“PMS”) (e.g., the “Oracle Hospitality OPERA Property” or the “Oracle Hospitality OPERA Cloud Services”) or an enterprise resource planning (“ERP”) system. A database 17 is coupled to bus 12 to provide centralized storage for modules 16 and 18 and store guest data, hotel data, transactional data, etc. In one embodiment, database 17 is a relational database management system (“RDBMS”) that can use Structured Query Language (“SQL”) to manage the stored data.

In one embodiment, particularly when there are a large number of hotel locations, a large number of guests, and a large amount of historical data, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as a IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based networking system, a software-as-a-service (“SaaS”) architecture, or other type of computing solution.

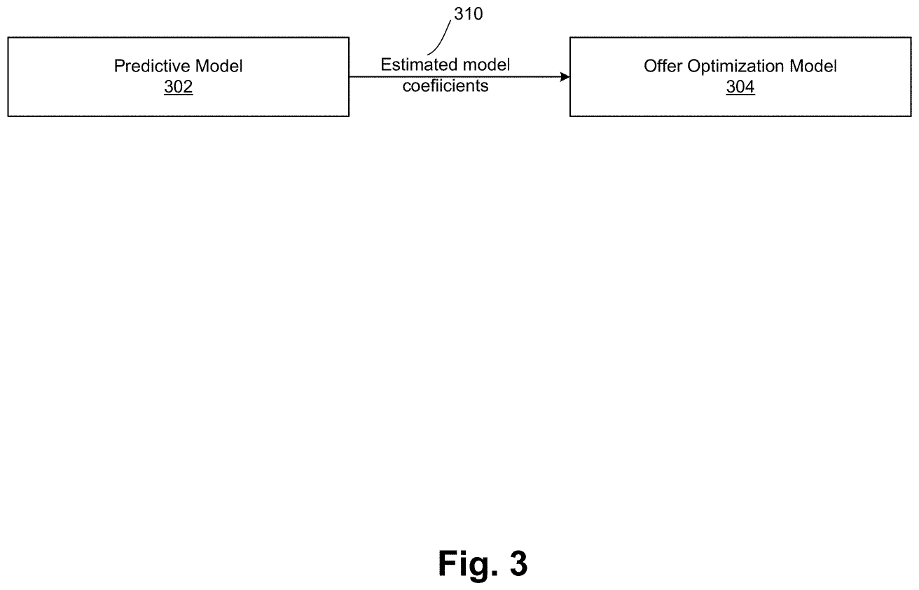

FIG. 3 is an overview block diagram of the functionality of system 100 of FIG. 1 in in accordance to embodiments of the invention. In one embodiment, predictive model 302 generates estimated model coefficients 310 (e.g., in embodiments described below, estimated α, β, γ coefficients). Predictive model 302 is a customer behavior model that determines the probability of booking each product (i.e., room-rate combination) based on its order in the list, price, and other factors including the customer persona. Predictive model 302 estimates coefficients by solving an optimization problem with coefficients as decision variables. The objective of predictive model 302 is to maximize the fitting of the model with given model variables' values. Details of one type of predictive model 302 in accordance to embodiments are disclosed below. In other embodiments, estimated model coefficients 310 can be generated using different functionality, examples of which are disclosed below.

Estimated model coefficients 310 are input to an offer optimization model 304, which generates the optimized ordering and display of hotel room choices. Given the estimated coefficient values, optimization model 304 finds the model variables' values to maximize the objective (i.e., maximize revenues).

Offer optimization model 304 uses decision variables of the prices and positions of the room options offered to the customer/guest. The decision variables include: (1) which room options to offer; (2) how to price the room options; and (3) how to arrange the room options. Offer optimization model 304 provides an optimized personalized searching recommendation offer and the ordering of the rate-grouped room types.

Optimized Display Ordering

In general, embodiments of offer optimization model 304 are an optimization system that provides a personalized display of the hotel booking options in real-time, with the objective to maximize the expected revenue using the probability computed from a multinomial logit (“MNL”) discrete-choice predictive model 302 trained on the historical observations. In order to personalize the displayed options, embodiments use “soft” clustering of the customer population by assuming that a customer belongs to each cluster with some probability that is predicted by a soft clustering model. The number of clusters is given as a hyper-parameter.

The optimization problem for a given mix of clusters is formulated as a set of fractional-linear programming problems, which are transformed using the Charnes-Cooper transformation (disclosed in Charnes, A.; Cooper, W. W. (1962), “Programming with Linear Fractional Functionals”. Naval Research Logistics Quarterly. 9 (3-4) into equivalent linear-programming problems that can be solved by a standard linear-programming package. Since the solution for a given mix of clusters cannot be obtained in “real-time” (e.g., less than 10 ms), embodiments pre-compute the optimal solutions for the points in the multidimensional grid of the fixed cluster mixes. When the cluster mix of a booking customer is determined by predictive model 302, a nearest point in the grid is found and the pre-computed solution is displayed.

Embodiments enable some degree of the hotel capacity control when the forecast for the future demand for each room category is known. In this case, embodiments can enforce the capacity constraint by using Lagrangian multipliers that are used as a virtual cost of overbooking the rooms. These multipliers are adjusted by using a variant of the gradient search in order to equate the projected demand to the capacity of each room category. As the result, the revenue derived from the high-demand room categories at the risk of over-booking is input into the optimization problem as artificially reduced by the Lagrangian multipliers, thus making it less appealing for booking in the optimal solution.

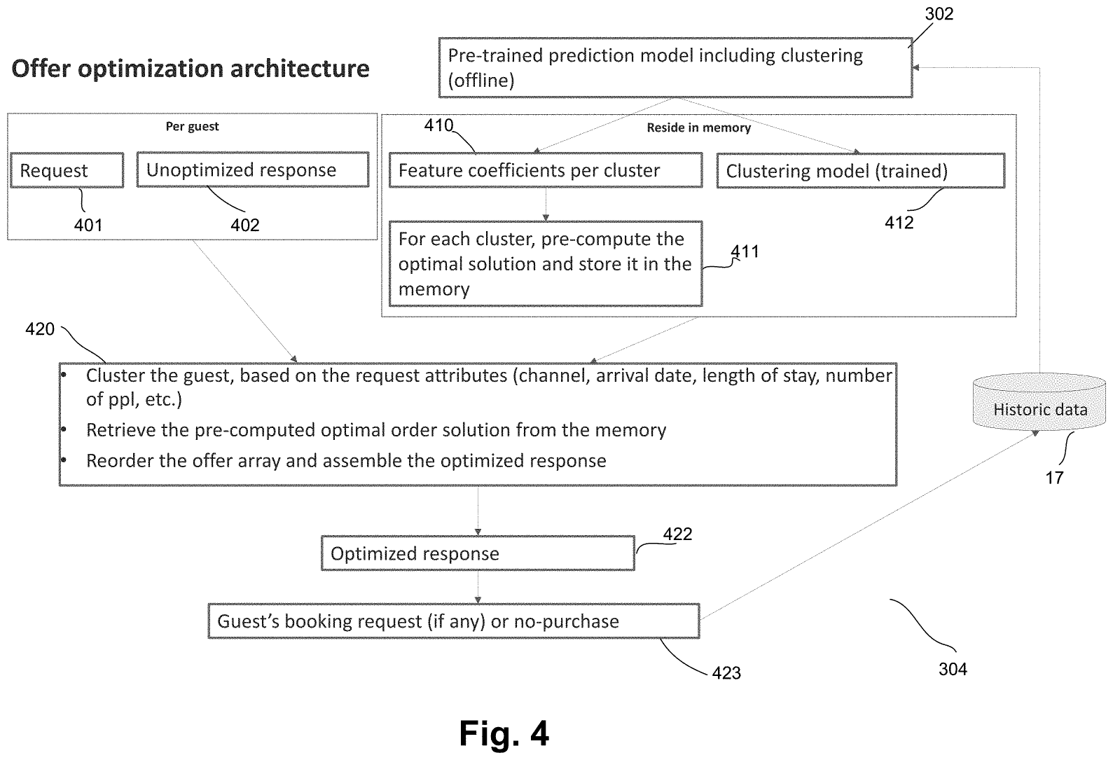

FIG. 4 is a architectural diagram of offer optimization model 304 of FIG. 3 in accordance to embodiments. Offer optimization model 304 receives, as input, pre-trained predictive/prediction model 302. In embodiments, pre-trained predictive model 302 is trained using dynamic clustering. Using prediction model 302 as input, offer optimization model 304 stores in memory (e.g., database 17) feature coefficients per cluster 410 and the clustering model 412, which is pre-trained as part of prediction model 302. In embodiments, as disclosed in more detail below, feature coefficients per cluster 410 include utility intercept αⱼ^{h} as well as cluster-specific price coefficient β^{h} and position effects γₘ^{h}.

On a per guest/customer basis, offer optimization model 304 receives a request 401 for reserving a hotel room and provides an unoptimized response 402. Response 402 provides an unoptimized list of room choices to be optimized by the embodiments. The initial unoptimized list of room choices is not presented to the hotel guest.

At 420, model 304 clusters the guest, based on the request attributes (channel, arrival date, length of stay, number of ppl, etc.), retrieves the pre-computed optimal order solution from the memory and reorder the offer array and assembles the optimized response. At 422, the optimized response is generated and presented as an optimized display of hotel room choices. At 423, the guest provides a booking request, based on selecting a choice from the optimized list, or no-purchases. The selection at 423 is stored in database 17 as historic data, and is provided to prediction model 302 which uses the selection as an additional iteration to further train prediction model 302.

### Deterministic Version

In general, the set of the future room-booking hotel guests, I, is not known exactly although it can be forecasted with some degree of certainty. However, in embodiments it is assumed that it is exactly known, which allows embodiments to solve a deterministic version of the problem. The closer to the arrival, the more accurate the guest count normally becomes, which will be reflected in the adjustments of the Lagrangian relaxation penalty as shown below.

Embodiments assume there are I customers, J products (i.e., hotel room/rate combinations) and M positions in the offer. Each customer belongs to each of H groups with the given probability πᵢₕ. Each product is characterized by a set of given parameters/coefficients that includes its utility intercept αⱼ^{h} as well as cluster-specific price coefficient β^{h} and position effects γₘ^{h}, respectively, where α, β, γ coefficients are estimated from the predictive model 302, described in detail below. The utility of choosing product j by a customer from cluster h is expressed as a linear function vᵢⱼₘ^{h}=αⱼ^{h}−β^{h}pᵢⱼ+γₘh, where pᵢⱼ is the price of product j in the product offer as seen by customer i. For all i, j, pᵢⱼ is in [p, p̅]. Further, as not all products may be shown to a customer, xᵢⱼₘ∈{0,1} is the offer inclusion variable indicating whether product j is assigned to position m and offered to customer i. Assuming that each customer can choose only one product and the probability of their choice is described by the multinomial logit (“MNL”) function of product utilities, the total revenue can be expressed as:

$$R = {\sum }_{i , j} {p}_{ij} \cdot {\sum }_{h} {π}_{ih} \frac{{\sum }_{m} {v}_{ijm}^{h} ( {p}_{ij} ) {x}_{ijm}}{1 + {\sum }_{j ′ = 1}^{J} {\sum }_{m ′ = 1}^{M} {v}_{ij ′ m ′}^{h} ( {p}_{ij ′} ) {x}_{ij ′ m ′}}$$

where vᵢⱼₘ^{h}=exp(vᵢⱼₘ^{h})=exp(αⱼ^{h}−β^{h}pᵢⱼ+γₘ^{h}).

The overall problem formulation is:

$$( P ) : max R = {\sum }_{i , j} {p}_{ij} \cdot {\sum }_{h} {π}_{ih} \frac{{\sum }_{m} {v}_{ijm}^{h} ( {p}_{ij} ) {x}_{ijm}}{1 + {\sum }_{{j}^{′} = 1}^{J} {\sum }_{{m}^{′} = 1}^{M} {v}_{{ij}^{′} {m}^{′}}^{h} ( {p}_{{ij}^{′}} ) {x}_{{ij}^{′} {m}^{′}}} \\ s . t . \qquad ( 1 )$$

$${\sum }_{i} {\sum }_{j ∈ {J}_{c}} {\sum }_{h} {π}_{ij} \frac{{\sum }_{m} {v}_{ijm}^{h} ( {p}_{ij} ) {x}_{ijm}}{1 + {\sum }_{{j}^{′} = 1}^{J} {\sum }_{{m}^{′} = 1}^{M} {v}_{{ij}^{′} {m}^{′}}^{h} ( {p}_{{ij}^{′}} ) {x}_{{ij}^{′} {m}^{′}}} \leq {B}_{c} , ∀ c ∈ C \qquad ( 2 )$$

$${\sum }_{j} {x}_{ijm} \leq 1 , ∀ i ∈ I , m ∈ M \qquad ( 3 )$$

$${\sum }_{m} {x}_{ijm} \leq 1 , ∀ i ∈ I , j ∈ J \\ {x}_{ijm} ∈ \{ 0 , 1 \} , ∀ i ∈ I , j ∈ J , m ∈ M \qquad ( 4 )$$

where B_{c} is the total availability of all products with resources in group c. In the hotel context, it is the number of rooms of the specific category c available on the specific night. The rooms from this category may be booked under different rate-plans (e.g., includes breakfast, fully refundable in case of cancellation, etc.) to form the product group J_{c} constrained by the availability of the rooms in the category. As products in different J_{c} sets correspond to different room categories, the J_{c} sets are disjoint. The constraints of equation 3 above ensure that at most one product is displayed in each position. The constraints of equation 4 above ensure that one product can be displayed in at most one position.

Let xᵢⱼₘ∈{0,1} be the offer inclusion variable indicating whether product j is assigned to position m and offered to customer i under price pᵢⱼ. Then denoting the hotel room capacity in category c by B_{c}, embodiments express the capacity constraint as follows:

$${\sum }_{i} {\sum }_{j ∈ {J}_{c}} {\sum }_{h} {π}_{ih} \frac{{\sum }_{m , k} {v}_{ijm}^{h} ( {p}_{ij} ) {x}_{ijmk}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}} \leq {B}_{c} .$$

Introducing Lagrange Multipliers {λ_{c}}_{c=1}^{c} as nonnegative constants, the Lagrange relaxation of the capacity constraints can be expressed by adding the capacity constraint violation to the objective function as shown in equation 5 below, Embodiments formulate a Lagrange Relaxation problem as indicated below:

$$max {\sum }_{i , j} {\sum }_{h} {π}_{ih} \frac{{\sum }_{m , k} {p}_{ij} \cdot {v}_{ijm}^{h} ( {p}_{ij} ) {x}_{ijm}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}} + {\sum }_{c} {λ}_{c} ( {B}_{c} - {\sum }_{i} {\sum }_{j ∈ {J}_{c}} {\sum }_{h} {π}_{ij} \frac{{\sum }_{m , k} {v}_{ijm}^{h} ( {p}_{ij} ) {x}_{ijmk}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}} ) \\ s . t . {\sum }_{j} {x}_{ijm} \leq 1 , ∀ i , m \\ {\sum }_{m} {x}_{ijm} \leq 1 , ∀ i , j \\ {x}_{ijm} ∈ \{ 0 , 1 \} , ∀ i , j , m \qquad ( 5 )$$

Which is equivalent to:

$$( {P}^{R} ) : max {\sum }_{i} {\sum }_{c} {\sum }_{j ∈ {J}_{c}} {\sum }_{h} {π}_{ih} \frac{{\sum }_{m} ( {p}_{ij} - {λ}_{c} ) {v}_{ijm}^{h} ( {p}_{ij} ) {x}_{ijm}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}} \\ s . t . {\sum }_{j} {x}_{ijm} \leq 1 , ∀ i , m \\ {\sum }_{m} {x}_{ijm} \leq 1 , ∀ i , j \\ {x}_{ijm} ∈ \{ 0 , 1 \} , ∀ i , j , m$$

### Single Cluster Case

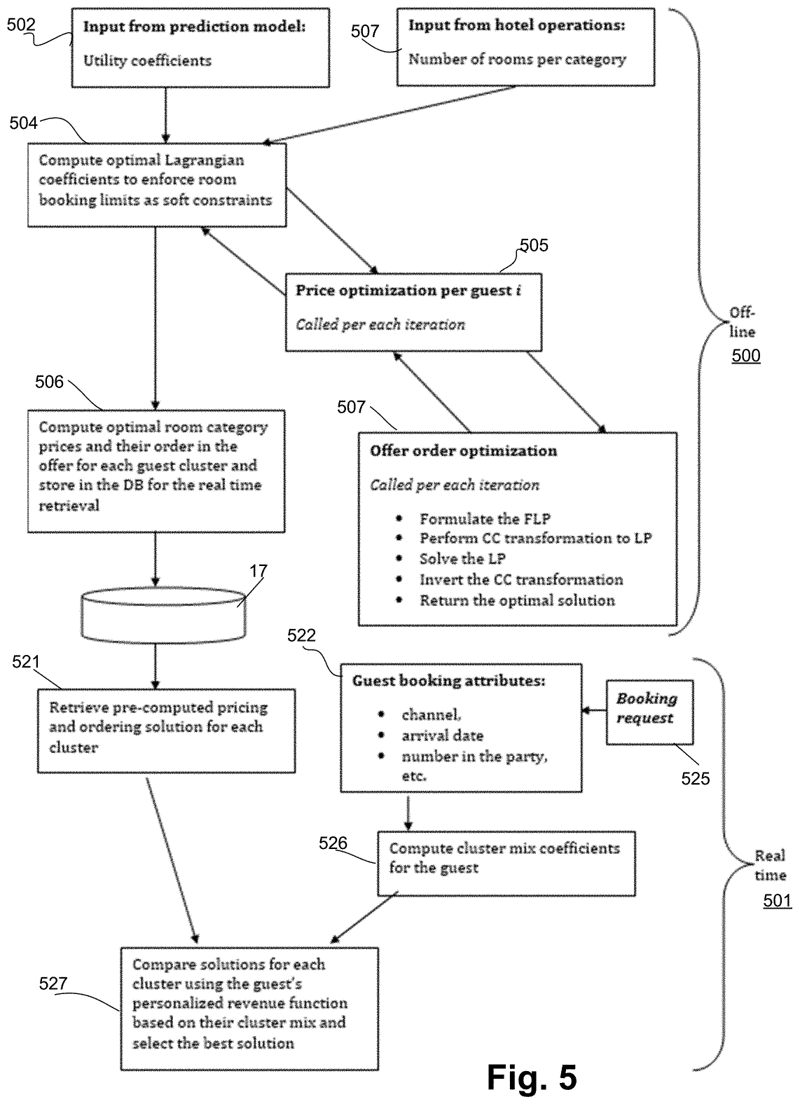

Since the solution of the problem for the cluster mixture is not computationally tractable, embodiments use the following heuristic to obtain a near-optimal solution: Obtain the assortment optimization solutions for each individual cluster and then, among these solutions, select the one that maximizes the expected revenue for the given cluster mix. The solutions for each individual cluster are pre-computed off-line and later retrieved in real time to speed up the computation, as shown below at 527 of FIG. 5. Obtaining a solution for a single cluster is disclosed as follows:

If embodiments with only have one cluster, the problem becomes:

$$( {P}^{RS} ) : {max}_{x ∈ {ℝ}_{+}^{JMK}} {\sum }_{c} {\sum }_{j ∈ {J}_{c}} \frac{{\sum }_{m , k} ( {p}_{ij} - {λ}_{c} ) {v}_{jm} ( {p}_{ij} ) {x}_{jm}}{1 + {\sum }_{{j}^{′} = 1}^{J} {\sum }_{{m}^{′}} {v}_{{j}^{′} {m}^{′}} ( {p}_{{ij}^{′}} ) {x}_{{j}^{′} {m}^{′}}} \qquad ( 6 )$$

$$s . t . {\sum }_{j} {x}_{jm} \leq 1 , ∀ m \qquad ( 7 )$$

$${\sum }_{m} {x}_{jm} \leq 1 , ∀ j \qquad ( 8 )$$

$${x}_{jm} ∈ \{ 0 , 1 \} , ∀ j , m \qquad ( 9 )$$

Since vⱼₘ(pₖ)≥0, the objective function is a fractional-linear function and is quasi-convex. Constraints of equations 7 and 8 above are totally unimodular. The integral constraints can be relaxed. Then, by the Charnes-Cooper transformation, (P^{LS}) is equivalent to

$$( {CC}^{RS} ) : {max}_{( y , {y}_{0} ) ∈ {ℝ}_{+}^{JMK + 1}} {\sum }_{c} {\sum }_{j ∈ {J}_{c}} {\sum }_{m , k} ( {p}_{j} - {λ}_{c} ) {v}_{jm} ( {p}_{j} ) {y}_{jmk} \qquad ( 10 )$$

$$s . t . {\sum }_{j} {y}_{jm} \leq {y}_{0} , ∀ m \qquad ( 11 )$$

$${\sum }_{m} {y}_{jm} \leq {y}_{0} , ∀ j \qquad ( 12 )$$

$${y}_{jm} \leq {y}_{0} , ∀ j , m \qquad ( 13 )$$

$${y}_{0} + {\sum }_{{j}^{′} = 1}^{J} {\sum }_{m} {v}_{jm} ( {p}_{j} ) {y}_{jm} = 1 \qquad ( 14 )$$

Therefore, the problem is reduced to solving a linear-programming problem.

Let (y*, y₀*) be a basic optimal solution of (CC^{RS}), then let

$${x}_{jm} = \frac{{y}_{jm}^{*}}{{y}_{0}^{*}}$$

(P^{RS}), it is shown that x* satisfy the constraints of equations 7 and 8 above, and also gives the same optimal value. As disclosed below, it can be illustrated that

$$\frac{{y}_{jm}^{*}}{{y}_{0}^{*}} ∈ \{ 0 , 1 \} .$$

Specifically, in a basic optimal solution (y*, y₀*) to

$$( {CC}^{RS} ) , \frac{{y}_{jm}^{*}}{{y}_{0}^{*}} ∈ \{ 0 , 1 \}$$

for all j∈[J], k∈[K], m∈[M], so the solution

$$\frac{{y}^{*}}{{y}_{0}^{*}}$$

is optimal to (P^{RS}).

As proof of the above, for the solution (y*, y₀*), defining the slack variables for the first three sets of constraints results in:

$${\sum }_{j , k} {y}_{jm}^{*} + {s}_{m}^{1 *} = {y}_{0}^{*} , ∀ m \qquad ( 15 )$$

$${\sum }_{m} {y}_{jm}^{*} + {s}_{j}^{2 *} = {y}_{0}^{*} , ∀ j \qquad ( 16 )$$

$${y}_{jm}^{*} + {s}_{jm}^{3 *} = {y}_{0}^{*} , ∀ j , m \qquad ( 17 )$$

$${y}_{0}^{*} + {\sum }_{{j}^{′} = 1}^{J} {\sum }_{m} {v}_{jm} ( {p}_{j} ) {y}_{jm}^{*} = 1 \qquad ( 18 )$$

By the constraints of equations 13 and 14, it is known that y₀*>0. Denote [symbol] ⁰={(j, m):yⱼₘ* is basic and sⱼₘ^{3*} is basic}, [symbol] ={(j, m):yⱼₘ* is basic and sⱼₘ^{3*} is nonbasic} and [symbol] ²={(j, m): yⱼₘ* is nonbasic and sⱼₘₖ^{3*} is basic}. | [symbol] ⁰|+| [symbol] ¹|+| [symbol] ¹|=JM. It is claimed that yⱼₘ*∈{0, y₀*} for all (j, m)∈ [symbol] ⁰. Define [symbol] ={m:sₘ^{1*} is nonbasic}, [symbol] ={j:sⱼ^{2*} is nonbasic}. Then the number of basic variables in (y*, y₀*, s^{1*}, s^{2*}, s^{3*}) is 1+2| [symbol] ⁰|+| [symbol] ¹|+| [symbol] ²|+M+J−| [symbol] |−| [symbol] |=1+| [symbol] ⁰|+JM+M+J−| [symbol] |−| [symbol] =1+JM+M+J. Therefore, | [symbol] ⁰|=| [symbol] |+| [symbol] |. Moreover, sₘ^{1*}=0 for m∈ [symbol] , sⱼ^{2*}=0 for j∈ [symbol] , and yⱼₘ*==0 for (j, m, k)∈ [symbol] ². And for all (j, m)∈ [symbol] ¹, yⱼₘ*=y₀*. So for m∈ [symbol] , j∈ [symbol] , there is the following:

$${\sum }_{j , k : ( j , m , k ) ∈ {𝒩}^{0}} {y}_{jm}^{*} = ( 1 - {\sum }_{j , k : ( j , m ) ∈ {𝒩}^{1}} 1 ) {y}_{0}^{*} \\ {\sum }_{m , k : ( j , m ) ∈ {𝒩}^{0}} {y}_{jmk}^{*} = ( 1 - {\sum }_{m , k : ( j , m ) ∈ {𝒩}^{1}} 1 ) {y}_{0}^{*}$$

Since | [symbol] ⁰|=|M|+| [symbol] |, the solution for the above two equations is unique and given by the inverse of the coefficient matrix and the right-hand side vector. The coefficient matrix is unimodular, so its inverse only has {−1,0,1}. Therefore, yⱼₘₖ* must be an integer multiple of y₀*. The result is yⱼₘₖ*∈{0, y₀*} for all (j, m)∈ [symbol] ⁰.

If (j, m)∈ [symbol] ⁰, then yⱼₘₖ*∈{0, y₀*}. If (j, m)∈ [symbol] ¹, then yⱼₘ*=y₀*. If (j, m)∈ [symbol] ², then yⱼₘ*=0. Therefore, ∀j, m, yⱼₘ*∈{0, y₀*}.

### Multiple Cluster General Case

The Lagrange Relaxation problem formulation shows that the maximization problem is independent on customers (on i). So (P^{R}) is equivalent to a sequence of subproblems (P^{R}ᵢ)ᵢ₌₁^{I}

$$( {P}_{i}^{R} ) : max {\sum }_{c} {\sum }_{j ∈ {J}_{c}} {\sum }_{h} {π}_{ij} \frac{{\sum }_{m} ( {p}_{ij} - {λ}_{c} ) {v}_{ijm}^{h} ( {p}_{ij} ) {x}_{ijm}}{1 + {\sum }_{{j}^{′} = 1}^{J} {\sum }_{{m}^{′}} {v}_{{ij}^{′} {m}^{′}}^{h} ( {p}_{{ij}^{′}} ) {x}_{{ij}^{′} {m}^{′}}} \\ s . t . {\sum }_{j} {x}_{ijm} \leq 1 , ∀ m \\ {\sum }_{m} {x}_{ijm} \leq 1 , ∀ j \\ {x}_{ijm} ∈ \{ 0 , 1 \} , ∀ j , m$$

First, letting

$${y}_{i}^{h} = \frac{1}{1 + {\sum }_{j} {\sum }_{m} {v}_{ijm}^{h} ( {p}_{ij} ) {x}_{ijm}}$$

the problem (P^{R}ᵢ) can be Dosed as:

$$max {\sum }_{c} {\sum }_{j ∈ {J}_{c}} {\sum }_{h} {π}_{ih} {\sum }_{m} ( {p}_{k} - {λ}_{c} ) {v}_{ijm}^{h} ( {p}_{ij} ) {x}_{ijm} {y}_{i}^{h} \\ s . t . {\sum }_{j , k} {x}_{ijmk} \leq 1 , ∀ m \\ {\sum }_{m , k} {x}_{ijmk} \leq 1 , ∀ j \\ {y}_{i}^{h} + {\sum }_{j} {\sum }_{m , k} {v}_{ijm}^{h} ( {p}_{k} ) {x}_{ijmk} {y}_{i}^{h} = 1 , ∀ h \\ 0 \leq {y}_{i}^{h} \leq 1 , ∀ j , m , k \\ {x}_{ijmk} ∈ \{ 0 , 1 \} , ∀ j , m , k \\ Let {z}_{ijmk}^{h} = {x}_{ijmk} \cdot {y}_{i}^{h} \\ ( {P}_{i}^{L} ) : max {\sum }_{c} {\sum }_{j ∈ {J}_{c}} {\sum }_{h} {π}_{ih} {\sum }_{m , k} ( {p}_{k} - {λ}_{c} ) {v}_{ijm}^{h} ( {p}_{k} ) {z}_{ijm}^{h} \\ s . t . {\sum }_{j , k} {x}_{ijm} \leq 1 , ∀ m \\ {\sum }_{m , k} {x}_{ijm} \leq 1 , ∀ j \\ {y}_{h} + {\sum }_{j} {\sum }_{m} {v}_{ijm}^{h} ( {p}_{ij} ) {z}_{ijm}^{h} = 1 , ∀ h \\ {z}_{ijm}^{h} \leq {y}_{h} , ∀ j , m , h \\ {z}_{ijm}^{h} \leq {x}_{ijm} , ∀ j , m , h \\ {y}_{h} - {z}_{ijm}^{h} \leq 1 - {x}_{ijm} , ∀ j , m , h \\ 0 \leq {y}_{h} \leq 1 , ∀ h \\ {x}_{ijm} ∈ \{ 0 , 1 \} , ∀ j , m \\ {z}_{ijm}^{h} \geq 0 , ∀ j , m , h$$

This problem changes to solve a mixed-integer linear formulation.

### Implementation Details

Embodiments solve the above problems using a linear-programming approximation algorithm, or a swap heuristic algorithm. Embodiments use the following heuristic algorithms with fixed prices and without capacity constraint:

$$( {P}^{R} ) : \qquad max {\sum }_{j} {\sum }_{h} {π}_{h} \frac{{\sum }_{m} {P}_{j} {v}_{jm}^{h} {x}_{jm}}{1 + {\sum }_{{j}^{′} = 1}^{J} {\sum }_{{m}^{′}} {v}_{{j}^{′} {m}^{′}}^{h} {x}_{{j}^{′} {m}^{′}}}$$

$$s . t . \qquad {\sum }_{j} {x}_{jm} \leq 1 , ∀ m$$

$${\sum }_{m} {x}_{jm} \leq 1 , ∀ j$$

$${x}_{jm} ∈ \{ 0 , 1 \} , ∀ j , m$$

### Linear-Programming Approximation

If there is only one cluster, the problem is equivalent to a linear-programming problem.
Solve the LP for each cluster to get H solutions (H is the number of clusters)
Calculate the expected revenue under the H solutions, choose the one with the largest expected revenue as the offer. (solved using Python linear programming “Pulp” in embodiments)

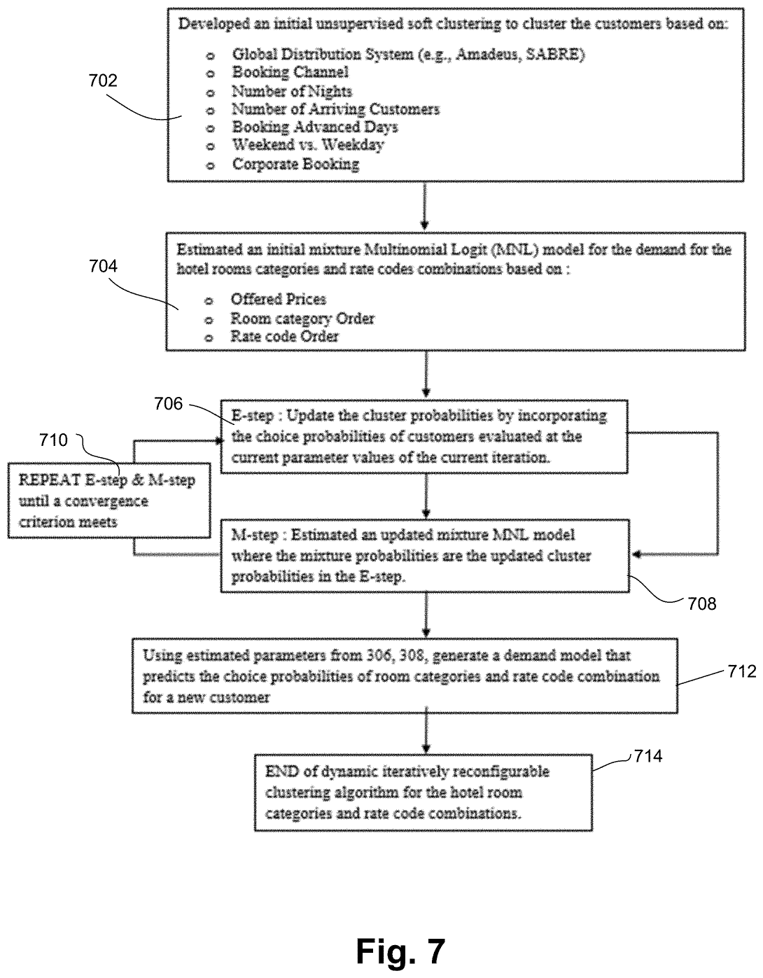

FIG. 5 is a flow diagram that illustrates the functionality of room hotel reservation system 100 of FIG. 1 in accordance to embodiments. In one embodiment, the functionality of the flow diagram of FIG. 5 (and FIG. 7 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The functionality of FIG. 5 includes an “off-line” portion 500 which uses the input from the pre-trained prediction model 302 in the form of the estimated parameter values of the model and pre-solves the single cluster problems for each individual cluster using the expected hotel bookings in anticipation of a customer requesting to reserve/book a hotel room. A “real-time” portion 501 is in response to the customer requesting a hotel room, and results in the optimized ordering of hotel room choices displayed to the customer.

Input data of FIG. 5 includes the input at 502 from pre-trained prediction model 302 (disclosed in detail below) of the utility coefficients (i.e., the estimated α, β, γ coefficients from the predictive model). In other embodiments, the utility coefficients can be provided using alternative methods (described below). At 503, the input from hotel operations is also received, such as the inventory of the number of available rooms per category based on the configuration of each hotel property as provided by the property management. For example, the hotel could be configured as having 100 rooms with two queen-size beds and 50 rooms with one king-size bed.

At 504, the optimal Lagrangian coefficients are determined to enforce room booking limits as soft constraints. At 504, the inputs include the α, β, γ utility coefficients as estimated from the predictive model (502) and per-category capacities B_{c} (503). The output is the optimal Lagrange coefficients λ_{c}*, c∈C as well as optimal prices and assortment of the offers for each cluster. This problem is solved by using a standard gradient-based continuous optimization procedure, which is performed as a nested iterative process. Each iteration performed at 504 includes determining the gradient of the optimal revenue as a function of the Lagrange coefficients, which involves determining the optimal revenue R₀(λ) for the current values of the coefficients λ by solving the price optimization problem at 505 using the gradient obtained by computing (B_{c}−totalDemandEstimate), as described in equation 5 above. At 504, the iterative process converges to the optimal Lagrange coefficients

$${λ}^{*} = arg {max}_{λ} {R}_{0} ( λ )$$

At 505, the price is optimized per guest i by implementing another iterative gradient search. At 505, the inputs include the Lagrangian coefficients λ_{c} from 504 and the α, β, γ utility coefficients as estimated from prediction model 302. At 505, the output is the optimal prices pᵢⱼ*. Each iteration of 505 involves determining the value of the optimal-order revenue function Rᵢ(pᵢⱼ, λ_{c}) by solving the offer sorting optimization problem at 507, which is then used in a standard gradient-based continuous optimization procedure such as L-BFGS-B as implemented in the “SciPy Optimize” package. As the gradient search at 505 finds only a local maxima, embodiments repeat the functionality at 505 multiple times by varying initial variable values in order to find the optimal prices

$${p}_{ij}^{*} = arg {max}_{{p}_{ij}} {R}_{i} ( {p}_{ij} , {λ}_{c} ) .$$

As function Rᵢ(pᵢⱼ, λ_{c}) may have multiple local maxima, the problem at the second step may have to be solved.

At 507, the offer order optimization for each guest i is determined. At 507, the input is: fixed prices pᵢⱼ per room category j; Lagrangian coefficients λ_{c} from 504 and utility values:

vᵢⱼ=αⱼ^{h(i)}−β^{h(i)}pᵢⱼ−γ^{h(i)}Σₘmxᵢⱼₘ, where α, β, γ coefficients are estimated from the predictive model from 502. At 507, the output is the optimal display order (position indicator variables):

xᵢⱼₘ*=1 if customer i is offered room category j at position m; 0, o.w.

Specifically, at 507, for each cluster h∈H, embodiments solve the Fractional Linear Programming (“FLP”) problem P^{RS} (equations 6-9 above) as the Linear Programming (“LP”) problem CC^{RS} (equations 10-14 above) using Charnes-Cooper (“CC”) transformation to obtain the optimal sorting of the offer for each individual cluster. Embodiments then invert the CC transformation to obtain the optimal sorting solution among the individual cluster solutions, and find the one that would maximize the cluster mix objective function of problem P^{R} as provided by equation 5 above.

The functionality of each of 504, 505 and 507 is performed iteratively to implement a gradient search at 504 and 505. Each iteration at 504 involves estimating the gradient of the function of the Lagrange coefficients by solving the optimization problem at 505, which is in turn solved iteratively with each iteration of estimating its own gradient by solving the optimization problem at 507.

At 506, the optimal room category prices and their order in the offer for each guest cluster is determined and stored in database 17 and/or higher speed memory to be used for the real-time retrieval.

Real-time portion 501 is initiated at 525 by receiving a booking request from a customer. The booking request for a specific property can include the information about the arrival and departure dates, possible discounts, booking channel, the number of people in the party including the number of children, and other attributes.

At 522, the guest booking attributes are retrieved from the booking request. The attributes include the booking channel, arrival date, number in the party, etc.

At 526, the cluster mix coefficients for the customer/guest corresponding to the booking request is determined based on the clustering model pre-trained as part of prediction model 302.

At 521, the pre-computed pricing and ordering solution for each cluster is retrieved from database 17 or higher speed memory.

At 527, solutions are determined for each cluster at 521 using the guest's personalized revenue function based on their cluster mix and the best solution is selected.

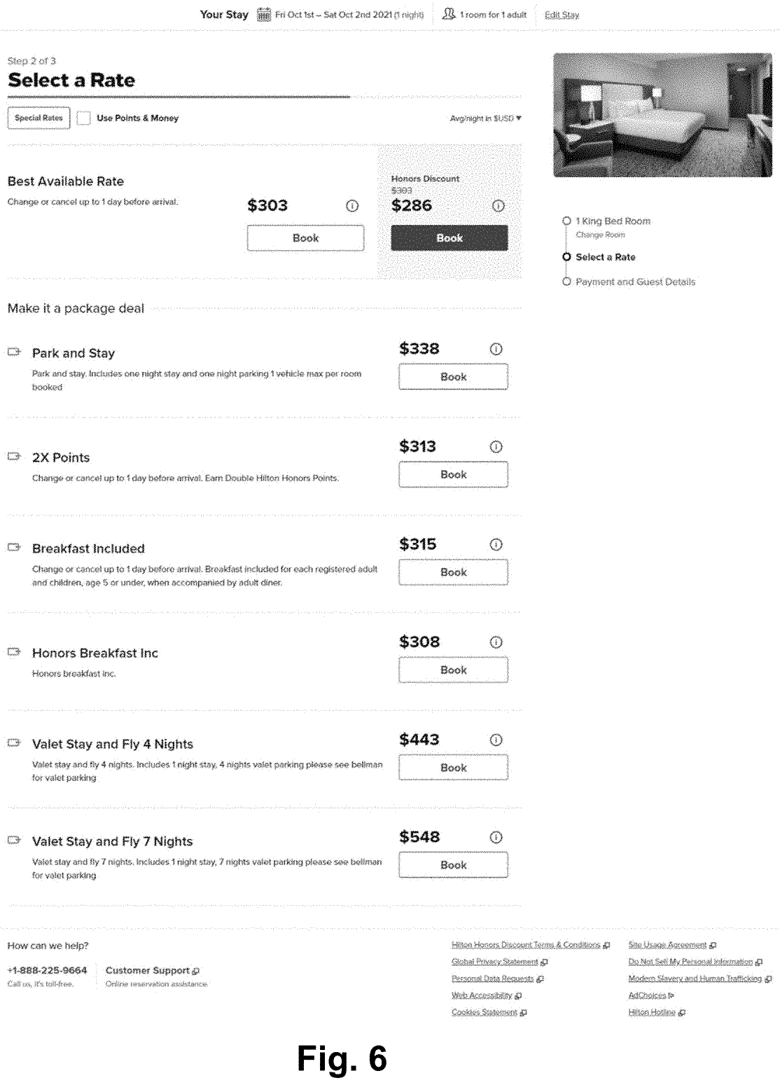

FIG. 6 illustrates an example output solution from the functionality of FIG. 5 in accordance to embodiments of the invention. As shown in FIG. 6, a specific display ordering of hotel room choices is displayed, with the display order optimizing revenue for the specific customer that provided the booking request.

As disclosed, embodiments provide the optimal personalized hotel room offers and an optimized display order of the room-rate pairs. Traditionally, the hotel industry ignores the heterogeneous customer population and instead treats customers as having a same demand and preference. Embodiments solve the offer optimization problem using a more accurate and sophisticated demand model which considers the customer's heterogeneity with significantly different patterns of purchase behavior. Embodiments provide customers with more accurate and more personalized offers, which recommends the best experiences for the hotel customers.

Further, embodiments solve an offer optimization problem with customers' heterogeneity. Since the offer optimization problem with heterogeneous customers is computationally hard and generally cannot be solved in real-time, it establishes a barrier for the application of the model. The tractable optimization approach implemented in embodiments is based on pre-solving multiple linear programming problems offline and storing their solutions to obtain a high-quality approximate solution for a given customer in real-time.

Embodiments are used in combination with the high-accuracy soft-clustering discrete-choice prediction model to enable the delivery of the revenue-maximizing solution in real-time. Further, embodiments are personalized based on the customer characteristics known from their booking query to the reservation system. Further, embodiments can be applied to enforce the booking constraints of the hotel room categories that may be overbooked during periods of high demand. Finally, the disadvantage of the potentially long running time of the optimization problem is overcome by storing the pre-computed solutions in memory (rather than DB tables) and their fast retrieval to form the offer.

### Swap Method

In an alternative embodiment, instead of using linear-programming as disclosed above, the following swap method can be used:
Initialization: Randomly generate a position order for J products.
For m=1:M, select the first m products and calculate the expected revenue R(x). Let \hat{x} be the solution that introduce the largest expected revenue and its revenue is R(\hat{x}).
Do:
   For all product pairs (j₁, j₂):
      Change the position of (j₁, j₂)
      For m=1:M, select the first m products and calculate the expected revenue R(x). If R(x)>R(\hat{x}). Update x̅=x, R(\hat{x})=R(x)
Until there is no update.
Output: \hat{x} and R(\hat{x})

Prediction Model

As disclosed above, in embodiments, prediction model 302 generates estimated model coefficients 310. Embodiments that use predictive model 302 predict the choice of the hotel room category and associated service type by customers based on estimating parameters of discrete-choice models built on dynamically determined clusters of observations. Each observation corresponds to the choice made by a customer booking a room in the hotel and selecting an associated type of service from an ordered set of room categories and service type pairs offered at certain prices. Each room category and type of service is described by a set of features determining the customer's value, or utility, of the choice. In addition, each customer is characterized by a set of their own attributes determining the cluster to which the customer belongs, also known as the “persona type.” It is assumed that each persona type may have its own utility of the booking choice.

The choice probability is modeled as a multinomial logit function based on the room-service pair utility for each persona type. Embodiments increase the accuracy of the prediction and build a basis for the prescriptive analytics application to optimize the personalized offer by maximizing the expected revenue. Embodiments can be used as a standalone system or as the central part of the personalized price optimization system for the personalized hotel rooms and the display optimization system for the order of the room category and rate code. Embodiments utilize iteratively reconfigurable dynamic clustering based on a semi-parametric mixture of discrete choice models to fully reflect a customers' choice behavior instead of using a static clustering traditionally used for this purpose.

In general, in the hotel industry, as well as other comparative industries, increased competition is driving more innovative revenue management practices such as personalized offers and pricing. Not all customers are the same, and a traditional one-size-fits-all policy might prove to be ineffective. Accurate estimation of demand as an input to a personalized recommendation system is crucial.

Embodiments solve the problem of predicting demand for multiple hotel room categories and service type combinations based on the hotel customer attributes, room category and service type features, offered price, and the order in which the room-rate pairs are presented to the customer. Rather than assuming homogeneous characteristics of the customers (i.e., where the expected demand should be the same when the same prices are offered), embodiments assume that the customer population includes several clusters to allow for customer characteristics and choice patterns to be heterogeneous across the clusters. In addition to predicting the demand of these heterogeneous customers (i.e., where the expected demand could be different, even when the same prices are offered), embodiments estimate the dynamic size of each cluster and centroid of each cluster recomputed over iterations to reflect the new assignments. The principal output of the problem is the probability of each individual customer booking a room in a specific room categories-service type combination.

Embodiments utilize a dynamic clustering approach to enable high-accuracy prediction of the room-service combination by a booking customer. Embodiments start with an initial clustering to divide customers into several clusters so that the characteristics of customers within each cluster can be more homogeneous than those from other clusters, and assume a personalized choice model within each cluster. Since cluster membership of customers (i.e., which cluster each customer belongs to) is unobservable, embodiments employ a soft clustering approach, in which the “mix” is captured through a customer's probability of belonging to each cluster.

To do so, embodiments implement unsupervised clustering using a random forest clustering algorithm with a certain number of clusters based on the characteristics of the potential hotel customers, orders of the room-service pairs, and their features, including the price offered. Next, embodiments derive a weighted likelihood function from the observed customers based on the discrete choice multinomial logit (“MNL”) models corresponding to the clusters with the weights set to the cluster probabilities obtained from the initial clustering. Then, embodiments maximize the weighted likelihood function to obtain the values of coefficients of each covariate and the intercept in the MNL models. Choice probabilities for multiple hotel room categories-service type combinations for each customer are calculated from those values. The number of clusters is selected to the value that delivers the best accuracy of the prediction.

In embodiments, the initial clustering is based on the customer features, not their choices. To incorporate the choice behavior of customers into clustering, embodiments update the weights as the initial clustering probabilities multiplied by choice probabilities calculated at the previous step, which can be viewed as the E-step of the Expected-Maximization (“EM”) algorithm. Then, embodiments re-fit the models with the newly formed clusters performing the dynamic clustering step by maximizing the updated weighted likelihood function, which constitutes the M-step of the EM algorithm. Finally, embodiments reiterate this E-step and M-step until the convergence criterion is met.

After the convergence, embodiments obtain the final estimates of the model parameters. For a new customer with their own characteristics, orders of the room-service pairs, and room category features, including the price offered, embodiments can predict the choice probabilities for the new customer after estimating their association with each cluster by solving a classification problem employing the supervised Random Forest classifier.

Dynamic Iteratively Reconfigurable Clustering Algorithm/Functionality

In general, embodiments implement a dynamic iteratively reconfigurable clustering algorithm/functionality for predicting demand in order to generate a hotel room demand model. Assume that a customer population of interest consists of multiple clusters G, where (G>1), where the pattern of booking a room is relatively homogeneous across customers within each cluster, while there is heterogeneity in booking patterns across clusters. Under this assumption, it is intuitive to consider different G choice models across clusters, i.e., a choice model fitted to each cluster separately. In practice, however, cluster membership indicating which cluster each customer belongs to is unobservable. In contrast, embodiments implement a novel algorithm/functionality to deal with the issue of estimating heterogeneous booking patterns of customers across clusters when cluster membership is unknown.

Specifically, assume that customer i is characterized by a set of observable covariates \vec{x}ᵢ, for i=1, . . . , n, where n is the number of customers in a data set. Let J be the number of products considered in a market, and Sᵢ be the set of available products to customer i, i.e., Sᵢ⊂{1, . . . , J}. Let yᵢ denote the product choice made by customer i, where yᵢ∈Sᵢ. Product j=1, . . . , J is characterized by a set of observable variables \vec{z}ⱼ. Then, the MNL room selection probability within cluster g can be expressed as follows. Letting [symbol] ᵢ be a cluster membership indicator for customer i,

$$P ( {y}_{i} = j \vert {ℓ}_{i} = g ) = \frac{exp ( {α}_{j}^{g} + {\vec{β}}_{g} {\vec{z}}_{ij} )}{{\sum }_{k ∈ {S}_{i}} exp ( {α}_{k}^{g} + {\vec{β}}_{g} {\vec{z}}_{ik} )} \qquad ( 20 )$$

where α_{B}^{g}=0 for identifiability and B∈{1, . . . , J} is the baseline product. In embodiments, B=J is set to demonstrate embodiments of the invention. Since the cluster membership indicator [symbol] ᵢ is unobservable, this is regarded as a latent variable and a model is needed to explain different probabilities of belonging to a cluster across different customer features. Specifically, assume a model for [symbol] ᵢ, called mixing distribution, as follows:

P( [symbol] ᵢ=g|xᵢ)=f_{g}(\vec{x}ᵢ) (21)

where f_{g}(\vec{x}ᵢ) is a generic notation for a probability mass function which depends on \vec{x}ᵢ, which is unknown.

One general approach to model [symbol] ᵢ is to assume an MNL (as known as logit) model, which specifies that a customer belongs to cluster g with probability

$$P ( {ℓ}_{i} = g \vert {\vec{x}}_{i} ) = {f}_{g} ( {\vec{x}}_{i} ) = \frac{exp ( {\vec{δ}}_{g} {\vec{x}}_{i} )}{{\sum }_{h = 1}^{G} exp ( {\vec{δ}}_{h} {\vec{x}}_{i} )} , \qquad ( 22 )$$

where embodiments set \vec{δ₁}=\vec{0} for identifiability. The vector \vec{δ}_{g} specifies how customer features affect in clustering, i.e., which cluster the customer belongs to. However, unlike the product choice yᵢ, the cluster membership indicator [symbol] ᵢ is unobservable, thus, the true structure of the mixing distribution is not known in practice and hard to test if the specified model is correct. A pre-specified parametric family for the mixing distribution as in equation (20) may not be consistent with the true mixing distribution, referred to as model misspecification problem, which leads to biased parameter estimates or low goodness-of-fit measures, which affects prediction accuracy.

To avoid such a model misspecification and improve a prediction performance, embodiments implement a semiparametric mixture of discrete choice models by assuming equations (20) and (21) rather than equations (20) and the MNL model (22). Letting the model parameters denote \vec{θ}={αⱼ^{g}, \vec{β}_{g}:j=1, . . . , J−1, g=1, . . . , G}, then, the likelihood function of \vec{θ} is written as

$$L ( \vec{θ} ) = {\prod }_{i = 1}^{n} {\sum }_{g = 1}^{G} P ( {ℓ}_{i} = g \vert {\vec{x}}_{i} ) {\prod }_{j ∈ {S}_{i}} {\{ \frac{exp ( {α}_{j}^{g} + {\vec{β}}_{g} {\vec{z}}_{ij} )}{{\sum }_{k ∈ {S}_{i}} exp ( {α}_{k}^{g} + {\vec{β}}_{g} {\vec{z}}_{ik} )} \}}^{I ( {y}_{i} = j )} \qquad ( 23 )$$

where there is not imposed any pre-specified parametric model form for P( [symbol] ᵢ=g|\vec{x}ᵢ) which can be estimated by using any nonparametric clustering method such as random forest. Other unsupervised machine learning techniques for clustering can also be used in other embodiments. Then, embodiments use the same idea of EM algorithm as follows. Suppose that the latent clustering membership indicator [symbol] ᵢ is known. Then, the complete likelihood function is

$${L}_{com} ( \vec{θ} ) = {\prod }_{i = 1}^{n} {\prod }_{g = 1}^{G} {{P ( {ℓ}_{i} = g \vert {\vec{x}}_{i} )}^{I ( {ℓ}_{i} = g )} [ {\prod }_{j ∈ {S}_{i}} {\{ \frac{exp ( {α}_{j}^{g} + {\vec{β}}_{g} {\vec{z}}_{ij} )}{{\sum }_{k ∈ {S}_{i}} exp ( {α}_{k}^{g} + {\vec{β}}_{g} {\vec{z}}_{ik} )} \}}^{I ( {y}_{i} = j )} ]}^{I ( {ℓ}_{i} = g )}$$

and the complete log-likelihood function is

$${ℓ}_{com} ( \vec{θ} ) = log {L}_{com} ( \vec{θ} ) = {\sum }_{i = 1}^{n} {\sum }_{g = 1}^{G} I ( {ℓ}_{i} = g ) log P ( {ℓ}_{i} = g \vert {\vec{x}}_{i} ) {\sum }_{j ∈ {S}_{i}} I ( {y}_{i} = j ) log \frac{exp ( {α}_{j}^{g} + {\vec{β}}_{g} {\vec{z}}_{ij} )}{{\sum }_{k ∈ {S}_{i}} exp ( {α}_{k}^{g} + {\vec{β}}_{g} {\vec{z}}_{ik} )} .$$

In the EM algorithm, the maximizer of the objective function of equation (23) can be found by using the following iterative method:

$${\vec{θ}}^{( t + 1 )} ← solve E \{ \frac{\partial {ℓ}_{com} ( \vec{θ} )}{\partial \vec{θ}} \vert y , x , z ; {\vec{θ}}^{( t )} \} = 0. \qquad ( 24 )$$

Specifically, embodiments repeat the following E-step and M-step as follows.

E-Step

Compute the conditional expectation of [symbol] ᵢ given the observed data {y, x, z}={yᵢ, \vec{x}ᵢ, \vec{z}ᵢⱼ:i=1, . . . , n, j∈Sᵢ}

π_{ig}^{(t)}=E( [symbol] ᵢ=g|y,x,z;\vec{θ}^{(t)})=P( [symbol] i=g|y,x,z;\vec{θ}^{(t)})

M-Step

Update the parameter \vec{θ} by solving the equation:

$$E \{ \frac{\partial {ℓ}_{com} ( \vec{θ} )}{\partial \vec{θ}} \vert y , x , z ; {\vec{θ}}^{( t )} \} = {\sum }_{i = 1}^{n} {\sum }_{g = 1}^{G} {π}_{ig}^{( t )} {\sum }_{j ∈ {S}_{i}} I ( {y}_{i} = j ) \frac{\partial }{\partial \vec{θ}} \{ log \frac{exp ( {α}_{j}^{g} + {\vec{β}}_{g} {\vec{z}}_{ij} )}{{\sum }_{k ∈ {S}_{i}} exp ( {α}_{k}^{g} + {\vec{β}}_{g} {\vec{z}}_{ik} )} \} .$$

As disclosed, embodiments employ an unsupervised clustering technique, such as random forest, based on customer features. Thus, the EM algorithm can be adjusted to a context, referred to as iterative reconfigurable clustering, as follows.

Initial Clustering:

Perform learning an unsupervised soft clustering (e.g., random forest, k-means) with G. Clusters based on the customer-level covariates {\vec{x}ᵢⱼ:i=1, . . . , n} and obtain the clustering probabilities for each cluster, pᵢ₁⁽⁰⁾, . . . , p_{iG}⁽⁰⁾, such that Σ_{g=1}^{G}p_{ig}⁽⁰⁾=1, where p_{ig}⁽⁰⁾ is the initial estimate of P( [symbol] ᵢ=g|\vec{x}ᵢ). With pᵢ₁⁽⁰⁾, . . . , p_{iG}⁽⁰⁾, we find the initial parameter values by solving the equations:

$${\sum }_{i = 1}^{n} {p}_{ig}^{( 0 )} \{ {\sum }_{j ∈ {S}_{i}} I ( {y}_{i} = j ) - \frac{exp ( {α}_{j}^{g} + {\vec{β}}_{g} {\vec{z}}_{ij} )}{{\sum }_{k ∈ {S}_{i}} exp ( {α}_{k}^{g} + {\vec{β}}_{g} {\vec{z}}_{ik} )} \} ( 1 , {\vec{z}}_{ij} ) = ( 0 , \vec{0} ) .$$

E-Step

Embodiments determine the conditional cluster probabilities by using the observed choice and the fitted discrete choice model as follows: if yᵢ=j,

$${π}_{ig}^{( t )} = P ( {ℓ}_{i} = g \vert {y}_{i} = j , {\vec{x}}_{i} , {\vec{z}}_{i} ) ∝ {p}_{ig}^{( 0 )} \times \frac{exp ( {\vec{β}}_{g}^{( t )} {\vec{z}}_{ij} )}{{\sum }_{j ∈ {S}_{i}} exp ( {\vec{β}}_{g}^{( t )} {\vec{z}}_{ij} )}$$

such that Σ_{g=1}^{G}π_{ig}^{(t)}=1.

M-Step

Update the choice model parameters to αⱼ^{g(t+1)} and \vec{β}_{g}^{(t+1)} by solving the following equations. For each g, first find the solutions of αⱼ^{g} for j=1, . . . , J−1 from the equation as follows.

$${\sum }_{i = 1}^{n} {π}_{ig}^{( t )} \{ {\sum }_{j ∈ {S}_{i}} I ( {y}_{i} = j ) - \frac{exp ( {α}_{j}^{g} + {\vec{β}}_{g}^{( t )} {\vec{z}}_{ij} )}{{\sum }_{k ∈ {S}_{i}} exp ( {α}_{k}^{g} + {\vec{β}}_{g}^{( t )} {\vec{z}}_{ik} )} \} = 0 .$$

Then obtain \vec{β}_{g}^{(t+1)} by solving the equation with respect to \vec{β}_{g}:

$${\sum }_{i = 1}^{n} {π}_{ig}^{( t )} \{ {\sum }_{j ∈ {S}_{i}} I ( {y}_{i} = j ) - \frac{exp ( {α}_{j}^{g ( t + 1 )} + {\vec{β}}_{g} {\vec{z}}_{ij} )}{{\sum }_{k ∈ {S}_{i}} exp ( {α}_{k}^{g ( t + 1 )} + {\vec{β}}_{g} {\vec{z}}_{ik} )} \} {\vec{z}}_{ij} = \vec{0} ,$$

where g=2, . . . , G.

Repeat the (E-step) and the (M-step) until the convergence criterion as ∥\vec{θ}^{(t+1)}−\vec{θ}^{(t)}∥₂<ϵ is met for any ϵ>0.

The above can be viewed as a variant of the EM algorithm. In embodiments, the “Theorem of Dempster et al. (1977)” can be applied to the proposed iterative algorithm, which says that the solution {\vec{θ}^{(t)}} converges to \vec{θ}*, where \vec{θ}* is the maximizer of our objective function, L(\vec{θ}).

Prediction of Room Categories and Rate Codes Combination

After convergence, embodiments obtain the final estimate of the model parameters {αⱼ^{g}, \vec{β}_{g}:j=1, . . . , J; 1, g=1, . . . , G}. For a new customer characterized by \vec{x}*, embodiments predict the choice probabilities as follows: letting S* be the available products, for j∈S* ,

$$P ( {y}^{*} = j \vert {\vec{x}}^{*} , {\vec{z}}^{*} ) = {\sum }_{g = 1}^{G} {p}_{g}^{*} \frac{exp ( {α}_{j}^{g} + {\vec{β}}_{g} {\vec{z}}_{ij}^{*} )}{{\sum }_{k ∈ {S}_{i}} exp ( {α}_{k}^{g} + {\vec{β}}_{g} {\vec{z}}_{ik}^{*} )} ,$$

where p_{g}* is the predicted probability of belonging to cluster g by the soft clustering, and \vec{z}ⱼ* is a feature vector of room j available to the new customer.

FIG. 7 is a flow diagram of the functionality of optimized display ordering module 16 of FIG. 2 for generating a room demand model as part of the optimized display ordering functionality in accordance with one embodiment.

At 702, an initial unsupervised soft clustering is developed to cluster customers based on a plurality of attributes/characteristics assigned to each customer. In embodiments, the attributes can include one or more of: (1) the global distribution system being used (e.g., Amadeus, SABRE, etc.); (2) the booking channel; (3) the number of nights; (4) the number of arriving customers; (5) booking advanced days; (6) weekend vs. weekday; (7) corporate booking.

The initial clustering at 702 is based on the customer features, not the customer choices. Customer features are those features that are known at the time of the request for the room, and include such data as the arrival date and time, the number in the party, and the booking channel. In addition, the customer feature data includes other inferred features such as the booking window (i.e., the time between the booking and arriving date).

The initial clustering, as well as the dynamic clustering which is described below where the initial clustering and subsequent clustering is dynamically updated, both incorporate machine learning. Specifically, the initial clustering at 702 can incorporate any unsupervised machine learning techniques for clustering, such as random forest, or soft clustering algorithms using Gaussian mixture models. Unlike with the choice of customers, the cluster membership is unobservable and therefore it is more challenging to assume a pre-specified parametric model about how clusters are formed based on the customer characteristics, and hard to test if the pre-specified parametric model is correct or not. Failure to specify a correct model leads to biased parameter estimates or low goodness-of-fit measures which affects prediction accuracy. Since embodiments do not require any pre-specified parametric model form for clustering structure, possible biases from model mis-specification can be avoided.

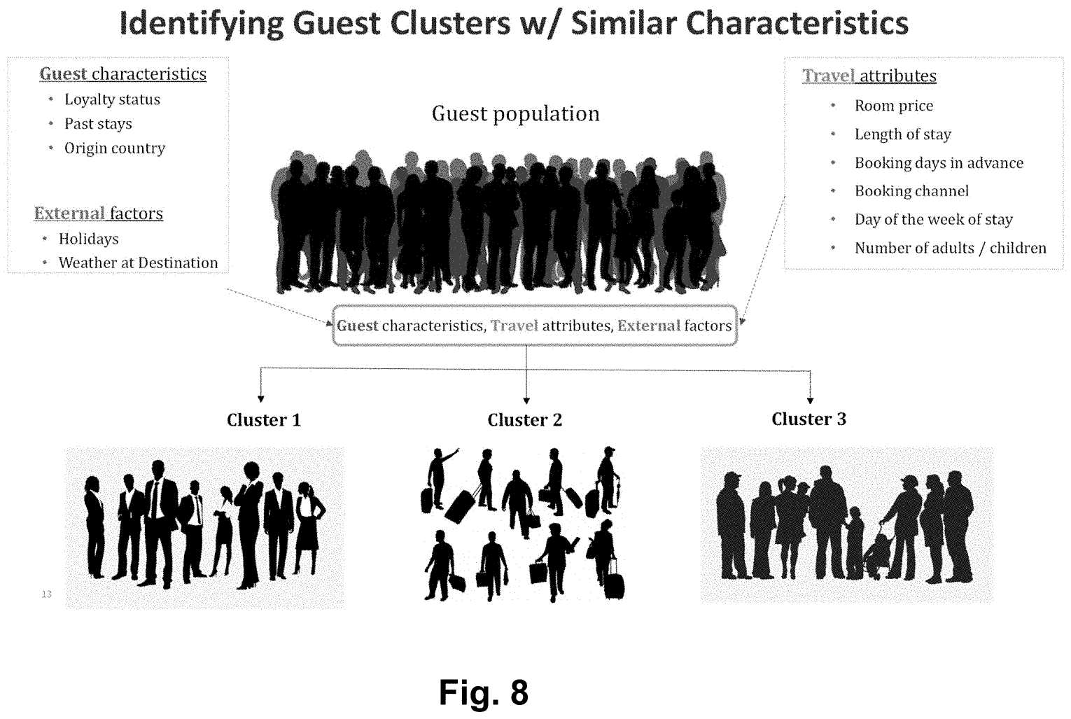

FIG. 8 illustrates an example of the initial clustering in accordance with embodiments. As shown in FIG. 8, based on the guest characteristics, external factors and travel attributes, three clusters are formed. In embodiments, the number of clusters is a predefined parameter based on the interpretability of the clustering, which typically limits the number of clusters to single digits. In various embodiments, two to four clusters are used.

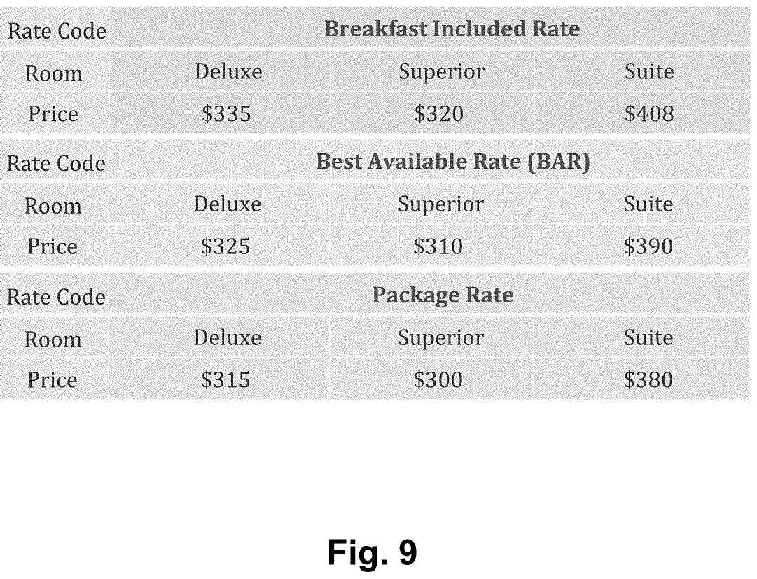

At 704, embodiments estimate an initial mixture of Multinomial Logit (“MNL”) models for the demand for the hotel room categories and rate codes combinations based on parameters related to the hotel room offerings, including: (1) Offered prices; (2) Room category and rate plan position in the offer; and (3) Room and rate features such as view, room size, whether the breakfast included, free cancellation, etc. For each cluster formed at 702, a separate MNL model is built at 704. FIG. 9 is an example illustrating various offered prices (e.g., $335), room categories (e.g., deluxe or superior. king or queen bed) and rate codes (e.g., “Breakfast Included Rate”). At 704, the historical booking data stored in a database (e.g., database 17 of FIG. 2) in order to estimate the \vec{θ} parameter defined in conjunction with equation (23) above on by solving equation (24) above.

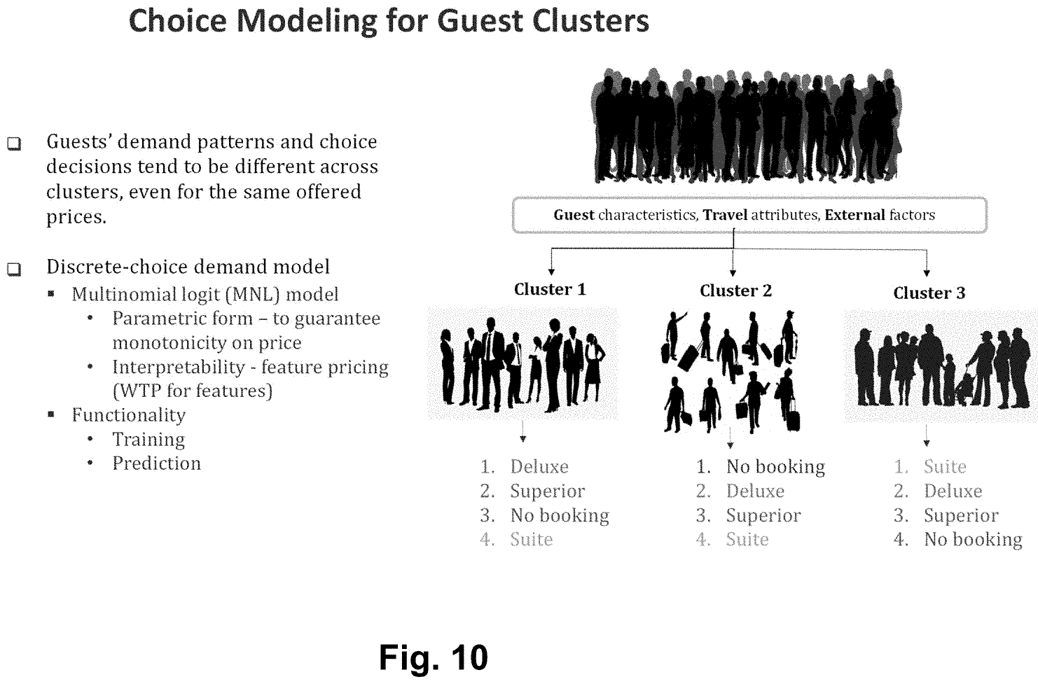

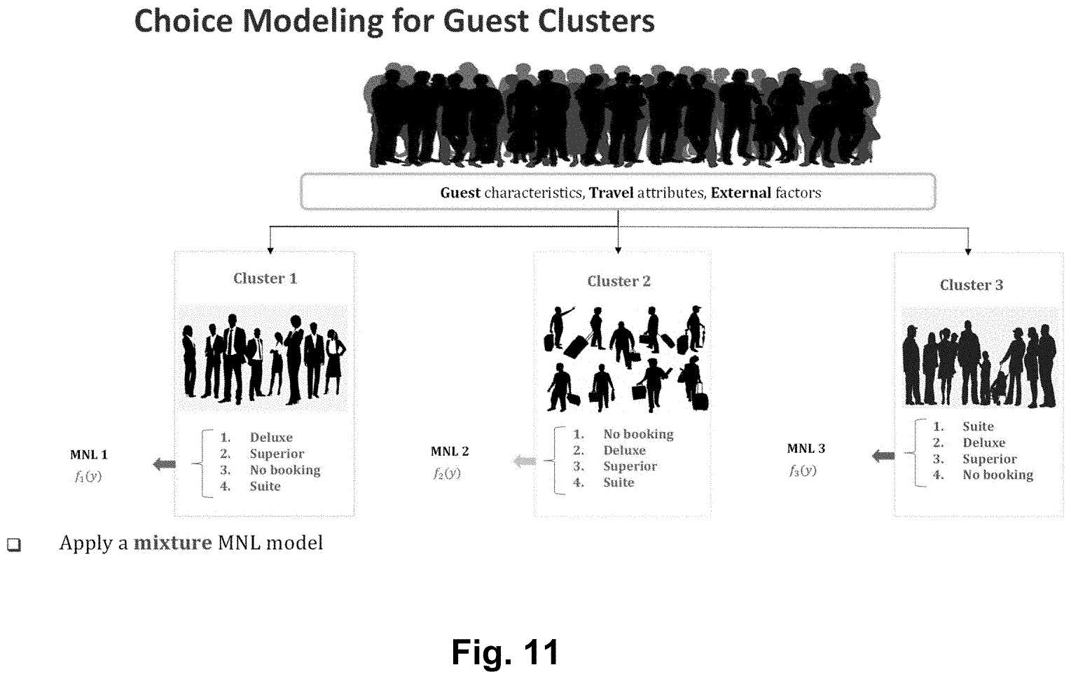

FIG. 10 illustrates the choice modeling for guest clusters in accordance to example embodiments. As shown in FIG. 10, each cluster uses a unique discrete choice model to predict the choice of the hotel room and rate code combination for each customer. FIG. 11 illustrates the initial assignment of an MNL model to each cluster in accordance to embodiments.

706, 708 and 710, collectively and on an iterative basis, form an Expectation Maximization (“EM”) functionality. The EM functionality includes 706, 708, and 710, where it also contains the soft-clustering which is updated in E-step at 706. Soft clustering at 702 is an initial clustering which is not repeated. At 706, for the Expectation “E-step”, the cluster probabilities are updated by incorporating the choice probabilities of customers evaluated at the parameter values of the current iteration.

At 708 for the Maximization “M-step”, embodiments estimate an updated mixture of MNL models where the mixture probabilities are the updated cluster probabilities in the E-step. At 710, 706 and 708 are repeated until the convergence criteria: |New Prediction Error −Old Prediction Error|<0.0001, is met.

At 712, using estimated parameters from 706, 708, a demand model is generated that predicts the choice probabilities of room categories and rate code combination for a new customer. At 714, the functionality ends.

The functionality of FIG. 7 combines the estimation of discrete choice modeling with a data-driven identification of customer segments and captures varying preferences of a heterogeneous customer population and provides interpretable model outputs. The demand model generated at 712 provides a practical approach that can help hoteliers profile their customers/guests based on their preferences, which can serve as a valuable input to: (1) formulate more efficient marketing policies and offer personalized recommendations that are more likely to be accepted; and (2) generate optimal personalized prices and display positions for each room type (e.g., suite with water view and queen bed).

As disclosed, embodiments incorporate a novel approach to predicting the customer choice and estimating the relative values of the room categories and service type features in the hotel industry based on the booking customers' attributes, orders of the room-service pairs in the offer, and offered price. Specifically, most of the demand-forecasting tools currently used by the hotel industry are aimed at providing the overall number of bookings based on a time series analysis assuming a single cluster (i.e., homogeneous customer population), thus ignoring heterogeneous customer populations. These demand modeling tools are often ineffective in the presence of heterogeneous customers with significantly different willingness-to-pay and patterns of behavior. Even if a few tools consider heterogeneous customer population, they employ a standard cluster algorithm which may not reflect the customer choice behaviors during the clustering process. Moreover, in general, no demand forecasting tools address the order of the room category-rate code pairs. The order of display on the website affects the customer's choice behavior in addition to the offered price.

Embodiments enable high-accuracy prediction of the room-service combination by a booking customer. Through the computational experiments, embodiments show that the prediction rate using a dynamic clustering approach achieves around 4% higher than the static clustering approach. Further, embodiments input the information on the order of the room category and rate code for the display optimization system, which can help hoteliers formulate more suitable marketing strategies and propose personalized recommendations that tend more to be accepted.

In addition, embodiments can incorporate any unsupervised machine learning techniques for clustering, such as random forest, or soft clustering algorithms using Gaussian mixture models, into the first step of the algorithm. Unlike the choice of customers, the cluster membership is unobservable, thus, it is more challenging to assume a pre-specified parametric model about how clusters are formed based on the customer characteristics, and hard to test if the pre-specified parametric model is correct or not. Failure to specify a correct model leads to biased parameter estimates or low goodness-of-fit measures which affects prediction accuracy. Since embodiments do not require any pre-specified parametric model form for clustering structure, possible biases from model miss-specification can be avoided.

Embodiments implement dynamic clustering as a form of machine learning, particularly when it involves training as with embodiments of the invention. Embodiments use unsupervised learning, which takes a set of data that contains only inputs, and find structure in the data, such as grouping or clustering of data points. Cluster analysis is the assignment of a set of observations into subsets, referred to as clusters, so that observations within the same cluster are similar according to one or more predesignated criteria, while observations drawn from different clusters are dissimilar. Different clustering techniques make different assumptions on the structure of the data, often defined by some similarity metric and evaluated, for example, by internal compactness, or the similarity between members of the same cluster, and separation, the difference between clusters. Dynamic clustering as a form of unsupervised online/incremental machine learning considers two concepts: (1) incrementality of the learning methods to devise the clustering model and (2) self-adaptation of the learned model (parameters and structure). Additional details on predictive model 302 are disclosed in U.S. patent application Ser. No. 17/399,342, filed on Aug. 11, 2021, the disclosure of which is hereby incorporated by reference.

The above embodiment implements predictive model 302 by fitting a parametric predictive model based onto historic data. The above embodiment uses likelihood maximization to find the values of the estimated coefficients that would maximize the likelihood of observing the historic data. Embodiments maximize the likelihood function using an optimization method.

In other embodiments, Bayesian inference is implemented. This is similar the above, but instead of maximizing the likelihood function to obtain a point estimate of the coefficients, embodiments perform a Monte Carlo simulation to obtain a probability distribution of the parameters. The coefficient values can then be obtained as the mean of the distribution.

In other embodiments, in the absence of the historic data, the coefficients can be obtained from a similar pre-trained model, similar to the transfer learning process, by estimating room feature coefficients in one hotel chain and reusing them in another.

In other embodiments, the coefficients can be set as configurable parameters based on some knowledge of the guest preferences. Later, as more data are collected from the observed guest behavior, these coefficient values could be adjusted. In this case, Bayesian inference as described above can be applied.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of optimizing display ordering of reservable hotel room choices for a hotel, the method comprising:
receiving a trained prediction demand model for the hotel, the trained prediction model comprising estimated coefficients;
receiving a total inventory of hotel rooms for the hotel;
determining optimal Lagrangian coefficients from the estimated coefficients using a first iterative gradient search;
determining optimized prices per customer based on the estimated coefficients and the optimal Lagrangian coefficients using a second iterative gradient search;
determining an offer order optimization per customer based on the optimal Lagrangian coefficients and using linear programming;
receiving a request for a hotel room from a first customer, the request comprising one or more attributes; and
based on the one or more attributes and the optimized prices per customer and the offer order optimization per customer, displaying an optimized ordered list of hotel room choices.

2. The method of claim 1, further comprising:
determining cluster mix coefficients for the customer based on the trained prediction model and the one or more attributes.

3. The method of claim 1, further comprising:
receiving a selection of one of the ordered list of hotel room choices;
based on the selection, further training the trained prediction model.

4. The method of claim 1, the optimized ordered list of hotel room choices maximizing revenue for the hotel.

5. The method of claim 1, the determining an offer order optimization per customer comprising solving a Fractional Linear Programming problem using a Charnes-Cooper transformation.

6. The method of claim 1, wherein the determining optimal Lagrangian coefficients, determining optimized prices per customer and the determining an offer order optimization per customer are performed iteratively.

7. The method of claim 1, wherein the attributes comprise one or more of arrival and departure dates, possible discounts, booking channel, or a number of people in a party.

8. The method of claim 1, wherein the trained demand model is generated comprising:
based on features of a potential hotel customer of the hotel, forming a plurality of clusters, each cluster comprising a corresponding weight and cluster probabilities;
generating an initial estimated mixture of multinomial logit (MNL) models corresponding to each of the plurality of clusters, the mixture of MNL models comprising a weighted likelihood function based on the features and the weights;
determining revised cluster probabilities and updating the weights;
estimating an updated estimated MNL models and maximizing the weighted likelihood function based on the revised cluster probabilities and updated weights; and
based on the update weights and updated estimated mixture of MNL models, generating the demand model that is adapted to predict a choice probability of room categories and rate code combinations for the potential hotel customer.

9. A computer readable medium having instructions stored thereon that, when executed by one or more processors, cause the processors to optimize a display ordering of reservable hotel room choices for a hotel, the optimize comprising:
receiving a trained prediction demand model for the hotel, the trained prediction model comprising estimated coefficients;
receiving a total inventory of hotel rooms for the hotel;
determining optimal Lagrangian coefficients from the estimated coefficients using a first iterative gradient search;
determining optimized prices per customer based on the estimated coefficients and the optimal Lagrangian coefficients using a second iterative gradient search;
determining an offer order optimization per customer based on the optimal Lagrangian coefficients and using linear programming;
receiving a request for a hotel room from a first customer, the request comprising one or more attributes; and
based on the one or more attributes and the optimized prices per customer and the offer order optimization per customer, displaying an optimized ordered list of hotel room choices.

10. The computer readable medium of claim 9, the optimize further comprising:
determining cluster mix coefficients for the customer based on the trained prediction model and the one or more attributes.

11. The computer readable medium of claim 9, the optimize further comprising:
receiving a selection of one of the ordered list of hotel room choices;
based on the selection, further training the trained prediction model.

12. The computer readable medium of claim 9, the optimized ordered list of hotel room choices maximizing revenue for the hotel.

13. The computer readable medium of claim 9, the determining an offer order optimization per customer comprising solving a Fractional Linear Programming problem using a Charnes-Cooper transformation.

14. The computer readable medium of claim 9, wherein the determining optimal Lagrangian coefficients, determining optimized prices per customer and the determining an offer order optimization per customer are performed iteratively.

15. The computer readable medium of claim 9, wherein the attributes comprise one or more of arrival and departure dates, possible discounts, booking channel, or a number of people in a party.

16. The computer readable medium of claim 9, wherein the trained demand model is generated comprising:
based on features of a potential hotel customer of the hotel, forming a plurality of clusters, each cluster comprising a corresponding weight and cluster probabilities;
generating an initial estimated mixture of multinomial logit (MNL) models corresponding to each of the plurality of clusters, the mixture of MNL models comprising a weighted likelihood function based on the features and the weights;
determining revised cluster probabilities and updating the weights;
estimating an updated estimated MNL models and maximizing the weighted likelihood function based on the revised cluster probabilities and updated weights; and
based on the update weights and updated estimated mixture of MNL models, generating the demand model that is adapted to predict a choice probability of room categories and rate code combinations for the potential hotel customer.

17. A hotel reservation system that optimizes a display ordering of reservable hotel room choices for a hotel comprising:
one or more processors coupled to stored instructions; and
a database storing historical booking data;
the processors configured to:
receive a trained prediction demand model for the hotel, the trained prediction model comprising estimated coefficients and based on the historical booking data;
receive a total inventory of hotel rooms for the hotel;
determine optimal Lagrangian coefficients from the estimated coefficients using a first iterative gradient search;
determine optimized prices per customer based on the estimated coefficients and the optimal Lagrangian coefficients using a second iterative gradient search;
determine an offer order optimization per customer based on the optimal Lagrangian coefficients and using linear programming;
receive a request for a hotel room from a first customer, the request comprising one or more attributes; and
based on the one or more attributes and the optimized prices per customer and the offer order optimization per customer, display an optimized ordered list of hotel room choices.

18. The hotel reservation system of claim 17, the processors further configured to:
determine cluster mix coefficients for the customer based on the trained prediction model and the one or more attributes.

19. The hotel reservation system of claim 17, the processors further configured to:
receive a selection of one of the ordered list of hotel room choices;
based on the selection, further train the trained prediction model.

20. The hotel reservation system of claim 17, the optimized ordered list of hotel room choices maximizing revenue for the hotel.
